(19) United States
(12) Patent Application Publication
(10) Pub. No.: US 2025/0379789 A1
(43) Pub. Date: Dec. 11, 2025

(54) SYSTEM AND METHOD FOR NETWORK CONFIGURATION

(71) Applicant: PALANTIR TECHNOLOGIES INC., Denver, CO (US)

(72) Inventors: David XIAO, Denver, CO (US); David Cohen, Denver, CO (US); Ellen Fu, Denver, CO (US); Ilya Nepomnyashchiy, Denver, CO (US); Stephen Freiberg, Denver, CO (US); Adam Skrocki, Denver, CO (US); Brendan Sudol, Denver, CO (US); Shun-Wen Yu, Denver, CO (US); Ryan Smith, Denver, CO (US)

(21) Appl. No.: 19/230,739

(22) Filed: Jun. 6, 2025

Related U.S. Application Data
(60) Provisional application No. 63/657,788, filed on Jun. 7, 2024.

(51) Int. Cl. H04L 41/0853

(52) U.S. Cl. CPC H04L 41/0853

(57) ABSTRACT

A system of a server is associated with channels, a plurality of client devices subscribed to the channels, and the server includes: one or more processors; and memory storing instructions that, when executed by the one or more processors, cause the system to perform operations comprising: receiving a system configuration change request from a client device, wherein the system configuration change request comprises a first system configuration file and channel information of a first channel; obtaining, based on the channel information, a second system configuration file that is currently deployed on client devices subscribed to the first channel; displaying, on a graphic user interface, a file comparison result between the first system configuration file and the second system configuration file; and in response to the file comparison result being verified, storing the first system configuration file in a request queue for the client devices to poll and deploy.

### FIELD OF THE INVENTION

This disclosure relates generally to systems and methods for configuration management across multiple computing environments. More specifically, it relates to automated synchronization and management of configuration settings across distributed environments in a network.

### BACKGROUND

In various industries, particularly in software and systems deployment, managing configurations across multiple distributed environments in a system is crucial. Each environment, potentially located in different geographical locations, needs to operate under a consistent configuration to ensure seamless functionality and integration. Traditionally, managing configurations in such distributed settings involved forward-deployed engineers manually setting up each environment. Engineers had to visit each environment's website, manually copy and paste settings, and ensure that data sharing setups were consistent across all platforms. This method was not only time-consuming and error-prone but also inefficient, particularly when scaling to dozens of environments, each with potentially different requirements.

In addition to the traditional manual configuration solutions, there exist semi-automatic configuration synchronization systems where a centralized server initiates system-wide configuration changes. In these systems, each environment may individually determine when and how to implement such configuration changes. Typically, the environments respond passively by either accepting or rejecting the configuration change requests, which are often delivered in the form of command lines or executable files from the centralized server. However, these systems do not allow individual environments to actively propose and initiate system-wide configuration changes that could automatically propagate such changes to other environments. This limitation restricts the flexibility and responsiveness of the system to evolving operational requirements and reduces the ability for localized innovation or rapid adaptation to specific needs.

To overcome these challenges, the invention proposes a configuration management service that automates the distribution of configurations from a central server to all subscribed environments. This service includes an approval workflow to safeguard against unintended changes and version control for rolling back to previous configurations if necessary. It also features a data flow dashboard for real-time monitoring and troubleshooting across environments, and it allows for local overrides of global settings to accommodate specific local needs without disrupting the overall system integrity.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings. Any principles or concepts illustrated in one figure may be applicable to any other relevant figures. For example, principles illustrated in FIG. 1A may also be applicable to any of FIGS. 1B, 2A, 2B, 3A, 3B, 4, 5, 6, 7, 8A, 8B, 9, and/or 10, and vice versa. The examples illustrated in the FIGS. are merely exemplary and used to illustrate general principles, which may be applied more broadly to different examples, such as different prompts and/or bodies of text.

FIG. 1A illustrates an example implementation or scenario of a computing system, which includes a central server 102 that automatically controls or manages data updates to and from local computing nodes.

FIG. 1B illustrates an example implementation of how the central server and local computing nodes are arranged.

FIGS. 2A and 2B illustrates an example implementation of synchronizing data updates by the central server 102, which includes a verification protocol.

FIG. 3A illustrates an example implementation of different modes of the local computing nodes, including a synchronized mode and an unsynchronized mode.

FIG. 3B illustrates an example diagram that illustrates switching between an unsynchronized mode and a synchronized mode.

FIG. 4 illustrates an exemplary implementation of schema version controlling, both at the central server and at the local computing nodes.

FIGS. 5-6 illustrate example presentations of data flow dashboards.

FIG. 7 illustrates a concept of priority channels, which are used to manage the priorities of data updates.

FIG. 8A illustrates a flow diagram in which a local computing node publishes a data update at a particular channel, and the central server synchronizes the data update to any local computing node subscribed to that particular channel, in some embodiments.

FIG. 8B illustrates an example implementation of updating of a configuration file.

FIG. 9 illustrates an implementation of a central server.

FIG. 10 illustrates potential downstream actions as a result of publication and synchronization of updates from and to local computing nodes as illustrated in the previous FIGS.

FIG. 11 is a block diagram that illustrates a computer system upon which any of the embodiments described herein may be implemented.

### SUMMARY

Some embodiments include a computer-implemented method by a server, wherein the server comprises a plurality of channels, and a plurality of client devices subscribed to the plurality of channels. The method comprises receiving a system configuration change request from a client device, wherein the system configuration change request comprises a first system configuration file and channel information of a first channel; obtaining, based on the channel information, a second system configuration file that is currently deployed on client devices subscribed to the first channel; displaying, on a graphic user interface (GUI), a file comparison result between the first system configuration file and the second system configuration file; and in response to the file comparison result being verified, storing the first system configuration file in a request queue for the client devices to poll and deploy.

In some embodiments, the computer-implemented method further comprises: computing a file fingerprint of the first system configuration file; searching for the file fingerprint in a hash list, the hash list comprising hashes of previously deployed system configuration files; and in response to the file fingerprint having no match in the hash list, generating the file comparison result by comparing the first system configuration file and the second system configuration file.

In other words, each system configuration file has a fingerprint, signature, or hash algorithm, like Message-Digest algorithm 5 (MD5). The fingerprint may be used to validate data integrity. Comparing the fingerprints of configuration files can quickly tell if the files are identical. The hash list records the fingerprints of all the previously deployed system configuration files. If the fingerprint of the incoming configuration file does not match with any of the fingerprints in the hash list, it means that it is a new configuration change request, which can be processed. The purpose of this step is to avoid deploying the same configuration change multiple times.

In some embodiments, the computer-implemented method further comprises: in response to the file fingerprint being matched in the hash list, sending an alert to the client device indicating that the first system configuration file is not being deployed. In other words, if the fingerprint of the incoming request matches with a previously deployed request, a user is alerted that this request has been previously processed, and the same configuration change will not be deployed again.

In some embodiments, the computer-implemented method further comprises: determining whether the request queue has a pending request that matches with the system configuration change request by comparing file fingerprints of the pending request and the system configuration change request; and in response to that the system configuration change request matches with any pending request in the request queue, removing the system configuration change request from the queue.

In some embodiments, the server may have a queue of pending requests (received from multiple clients) to be processed. If a new request comes in, the server checks if there is an identical request in the queue (e.g., two clients sending two identical requests to the server). If there is an identical request, the new request will be deduplicated.

In some embodiments, the computer-implemented method further comprises: generating a dashboard displaying the plurality of channels, the client devices subscribed to each of the plurality of channels, and current system configurations on the client devices.

In some embodiments, one client device is permitted to subscribe to more than one of the plurality of channels.

In some embodiments, the system configuration change request is channel-specific, and only client devices subscribed to the first channel are allowed to poll the system configuration change request.

In some embodiments, the computer-implemented method further comprises: storing a list of the client devices subscribed to the first channel; receiving a local overriding request from a second client device in the client devices, wherein the local overriding request indicates that the second client device is intended to make local changes to the first system configuration file; temporarily removing the second client device from the list; and enforcing, based on the first system configuration file, a system configuration update on the remaining client devices in the list.

In some embodiments, the displaying the file comparison result between the first system configuration file and the second system configuration file on the GUI comprises: displaying a window comprising a first area and a second area, wherein the first system configuration file is displayed in the first area, and the second system configuration file is displayed in the second area; and highlighting code differences between the first system configuration file and the second system configuration file using color coding.

In some embodiments, the computer-implemented method comprises: sending, periodically, configuration probing requests to the client devices to obtain status of the deployment of the first system configuration file on the client devices; and receiving hashes from the client devices, wherein the hashes represent configuration files deployed on the client devices.

In some embodiments, the computer-implemented method comprises: storing the second system configuration file in a log file, allowing a system-wise roll-back from the deployed first system configuration file to the second system configuration file.

In some embodiments, the computer-implemented method comprises: collecting network traffic data between the server and the plurality of client devices, the network traffic data comprising at least one of network delay, package loss, or jitter; in response to the network traffic data between the server and a third client device being greater than a threshold, adding the first system configuration file into a cache queue associated with the third client device, wherein the cache queue stores one or more system configuration files that are not yet deployed on the third client device; and in response to the network traffic data between the server and a third client device being below the threshold, deploying the one or more system configuration files in the cache queue sequentially onto the third client device.

Some embodiments comprise a system of a server, wherein the server comprises a plurality of channels, a plurality of client devices subscribed to the plurality of channels, and the server comprises: one or more processors; and memory storing instructions that, when executed by the one or more processors, cause the system to perform operations comprising: receiving a system configuration change request from a client device, wherein the system configuration change request comprises a first system configuration file and channel information of a first channel; obtaining, based on the channel information, a second system configuration file that is currently deployed on client devices subscribed to the first channel; displaying, on a graphic user interface (GUI), a file comparison result between the first system configuration file and the second system configuration file; and in response to the file comparison result being verified, storing the first system configuration file in a request queue for the client devices to poll and deploy.

Some embodiments comprise a non-transitory computer readable media of a server, wherein the server comprises a plurality of channels, a plurality of client devices subscribed to the plurality of channels, and non-transitory computer readable media comprises instructions that, when executed, cause one or more processors to perform operations comprising: receiving a system configuration change request from a client device, wherein the system configuration change request comprises a first system configuration file and channel information of a first channel; obtaining, based on the channel information, a second system configuration file that is currently deployed on client devices subscribed to the first channel; displaying, on a graphic user interface (GUI), a file comparison result between the first system configuration file and the second system configuration file; and in response to the file comparison result being verified, storing the first system configuration file in a request queue for the client devices to poll and deploy.

Some embodiments further comprise a Large Language Model (LLM) that receives a request to synchronize a data update at a client device, publishes the data update to a channel to which the client device is subscribed, and synchronizes the client device according to the published data update.

### DETAILED DESCRIPTION

A computing system may include local computing nodes and a central server. Local computing nodes, which may include stacks or local servers, may be subscribed to one or more particular channels. In some embodiments, the computing system may be arranged in a mesh or mesh-like arrangement. The particular channels may include any data or data representations that control or affect operations of the local computing nodes. The data may include or indicate an ontology, feature flags, activated and/or deactivated features, any settings or features activated upon turning on or starting up a local computing node, and/or any settings or features external to or in conjunction with source code. Thus, by subscribing to the particular channels, the local computing nodes may be connected with other local computing nodes that are related. Each of the local computing nodes may publish data updates and/or receive data updates published or originated by other local computing nodes. In some embodiments, the central server may control and/or manage the publication of a data update, to a particular channel, from one or more local computing nodes and selectively synchronize or propagate any published data updates to local computing nodes that are subscribed to the particular channel. In some embodiments, the subscriptions of the local computing nodes may be associated with different priorities. For example, a first channel having a higher priority than a second channel means that if the first channel and the second have same or equivalent data, then synchronization would be taken from the first channel, if available.

The data may be manifested as artifacts, objects, documents, files (e.g., configuration files), payloads, and/or any other data representations. Each particular channel may correspond to a group or pipeline of configuration documents or a group of common environments. Each channel may define a particular path through which particular data representations are distributed. In some embodiments, some channels may be defined or correspond to different types or categories of environments. Each channel may have access controls, such that only data or data updates made by authorized personnel, and/or data having or not having certain markings are permitted to be ingested into the channel. For example, channels may be defined based on different stages of programming deployment, such as one channel being defined as a production environment and another channel being defined as a test environment. In some embodiments, some channels may be defined or correspond to different computing tasks. For example, one channel may be defined to include data, metadata, and/or other protocols or settings that support mapping tasks, while another channel may be defined to include data, metadata, and/or other protocols or settings that support imaging tasks. In some embodiments, one document may be restricted to be stored within only a single channel. However, same or similar data content may be stored in different channels as different data identifiers.

In some embodiments, the computing system supports configuration distribution across the local computing nodes, which synchronizes any relevant data updates to any local computing nodes that have subscribed to a channel that has been updated. This process is an improvement over not only existing time-consuming manual processes that transmit data across different local computing nodes, but is also an improvement over any other hypothetical computing process that performs configuration distribution. Benefits include efficiency, reliability in that error in configuration updates are minimized or eliminated, and scalability or versatility in deploying across different sized environments. In some embodiments, the computing system also supports a verification protocol to ensure that a subscribed local computing node is intending to receive certain updates from a particular channel. In some embodiments, during the verification process, if a particular local computing node is subscribed to a particular channel, and a new data representation is published at the particular channel to the central server, the central server may determine if a corresponding or similar data representation already exists in the particular local computing node. If such a corresponding data representation exists in the particular local computing node, the central server may determine a difference between the new data representation and the corresponding data representation. The central server may delay the synchronization of the new data representation into the particular local computing node until receiving of approval. This approval may be from an administrator corresponding to the particular channel or the particular local computing node. In some embodiments, if the central server does not receive an approval, the central server will refrain from synchronizing the new data representation. In this manner, the central server may ensure an intention of the particular local computing node to synchronize any updates from the central server.

The computing system also supports different modes at each of the local computing nodes, such as an unsynchronized mode and/or a synchronized mode. The central server may receive, from any particular local computing node, an indication of whether that particular local computing node is switching between modes. During the unsynchronized mode, any proposed changes at a local computing node are not published to the central server, and any obtained changes from other local computing nodes are not synchronized at the local computing node. Additionally or alternatively, the computing system may support a combination of an unsynchronized mode and a synchronized mode at a particular local computing mode. For example, the central server may receive, from the particular local computing node, an indication that the particular local computing node is to have certain data updates synchronized but other data updates unsynchronized. Unsynchronized data updates may refer to any published data updates that are not propagated to the particular local computing node.

The computing system also supports control of schema versioning both at the central server and at each of the local computing nodes. In some embodiments, the central server may obtain a base schema version based on a lowest common schema version across all the local computing nodes. The schema versions implemented across the local computing nodes may be defined according to data fields and/or data types supported. The base schema version may define a particular schema version for which data updates are published to the central server. The central server may update the base schema version in response to receiving, from any local computing nodes that employ a lowest schema version, an updated data representation that has an updated schema version. In some embodiments, the central server may also coordinate updating of schema versions across the local computing nodes. For example, the coordinating of the updating of schema versions may include, indicating to each of the local computing nodes when to update a schema version based on a time that all of, or a majority of, the local computing nodes support the updated schema version. This may facilitate more consistent schema versions across the local computing nodes, which may reduce the conversion, at the local computing nodes, of data representations between different schemas.

Additionally, the computing system supports a centralized data flow, accessible at the central server, that includes a dashboard including job statuses across the local computing nodes. The computing system may also support a localized data flow, accessible at each of the local servers, that includes a dashboard including job statuses specific to each of the local servers.

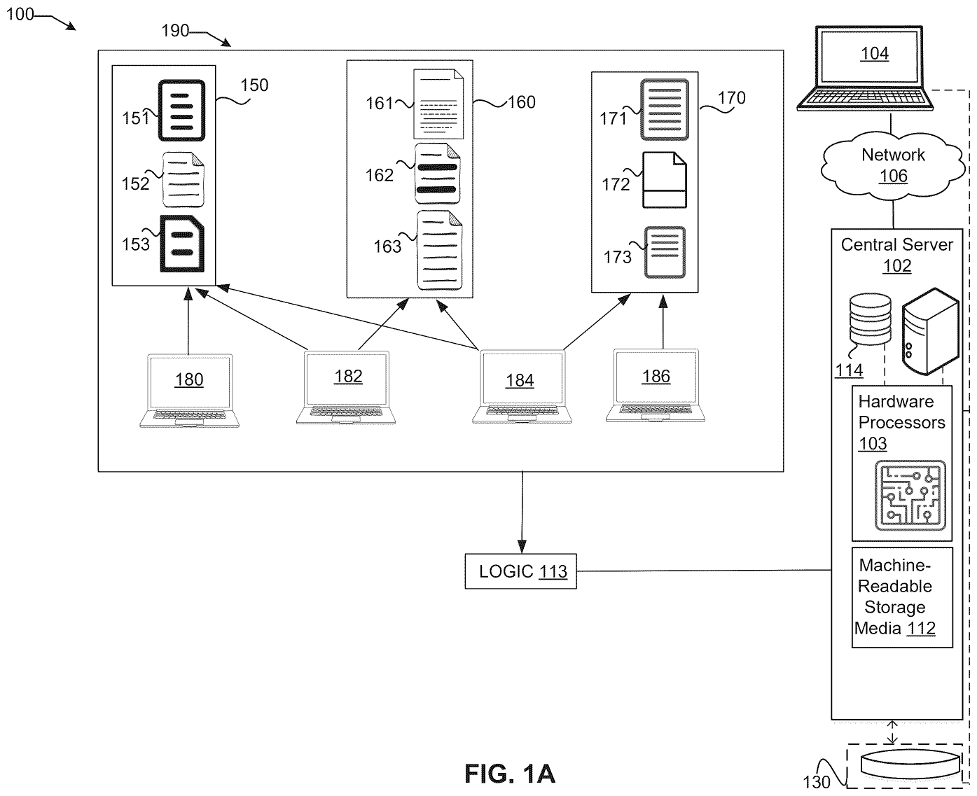

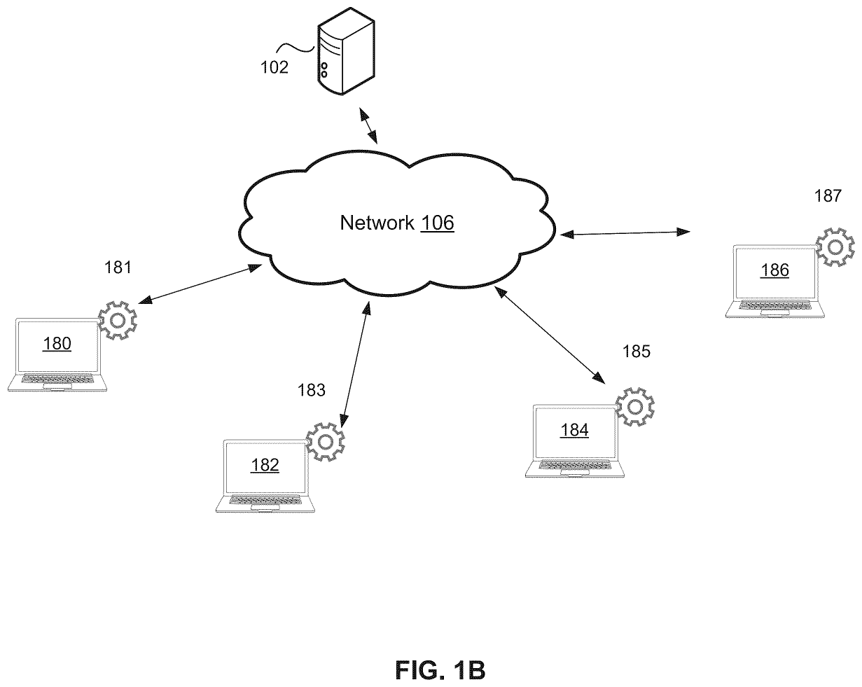

FIG. 1A illustrates an example implementation or scenario of a computing system 100, which includes a central server 102 that automatically controls or manages data updates to and from local computing nodes, which includes configuration synchronization across the local computing nodes, a verification protocol or workflow prior to initial synchronization of a document, implementing of different operational modes of the local computing nodes, and populating of a data flow dashboard that includes job statuses.

The computing system 100 can include at least one computing device 104 which may be operated by an entity such as a user or administrator of the central server 102. The user may submit a request or query through the computing device 104. The computing device 104 may receive the request or query from a user or from another computing device, computing process, or pipeline. Such a request or query may relate to operations on or pertaining to a request or query to view and/or modify one or more operations of data synchronization across the local computing nodes. A portion or all of the results of the data synchronization, such as history of jobs (e.g., data synchronizations across local computing nodes), statuses of the local computing nodes including which channels the local computing nodes are subscribed to and statuses of current jobs such as completed, pending, or error statuses, health statuses of any jobs and/or local computing nodes, may be stored in a database 130. In general, the user can interact with the database 130 directly or over a network 106, for example, through one or more graphical user interfaces, application programming interfaces (APIs), and/or webhooks. The computing device 104 may include one or more processors and memory. In some examples, the computing device 104 may visually render any outputs.

The computing system 102 may include one or more processors 103 which may be configured to perform various operations by interpreting machine-readable instructions, for example, from a machine-readable storage media 112. In some examples, one or more of the processors 103 may be combined or integrated into a single processor, and some or all functions performed by one or more of the hardware processors 103 may not be spatially separated, but instead may be performed by a common processor. The processors 103 may be physical or virtual entities. For example, as virtual entities, the processors 103 may be encompassed within, or manifested as, a program within a cloud environment. The processors 103 may constitute separate programs or applications compared to machine learning components. The computing system 102 may also include a storage 114, which may include a cache for faster access compared to the database 130. The storage 114 may store a subset of (e.g., a portion or all) of the information within the database 130.

The processors 103 may further be connected to, include, or be embedded with logic 113 which, for example, may include, store, and/or encapsulate instructions that are executed to carry out the functions of the processors 103. In general, the logic 113 may be implemented, in whole or in part, as software that is capable of running on the computing system 102, and may be read or executed from the machine-readable storage media 112. The logic 113 may include, as nonlimiting examples, parameters, expressions, functions, arguments, evaluations, conditions, and/or code. Here, in some examples, the logic 113 encompasses functions of or related to synchronization of data updates across the local computing nodes. Additionally or alternatively, the logic 113 may generate a graphical representation of historical jobs and current statuses of local computing nodes and/or current jobs.

Functions or operations described with respect to the logic 113 may be associated with a single processor or multiple processors. Functions or operations within the logic 113 will be subsequently described.

The logic 113 may be configured to organize or categorize data across different channels. The logic 113 may be configured to receive subscriptions, by local computing nodes, to one or more channels. The logic 113 may be configured to receive, by a subscribed local computing node, publications of data and/or data updates to a particular channel that has been subscribed to, and to selectively synchronize any data updates to any local computing nodes that have subscribed to a particular channel.

In some embodiments, the computing system 100 may include a distributed computing system 190, which includes local computing nodes 180, 182, 184, and 186, which may be subscribed to one or more channels 150, 160, and/or 170. The channel 150 may have documents 151, 152, and 153. The channel 160 may have documents 161, 162, and 163. The channel 170 may have documents 171, 172, and 173. Although four local computing nodes and three particular channels are illustrated for exemplary purposes, any number of local computing nodes and any number of channels may be contemplated. Here, the local computing node 180 may be subscribed to the particular channel 150, which may have documents 151, 152, and 153. The local computing node 182 may be subscribed to the channels 150 and 160. The local computing node 184 may be subscribed to the channels 150, 160 and 170. The local computing node 186 may be subscribed to the channel 170. A subscription means that a local computing node may publish any data updates to that channel and/or receive data updates from that channel. For example, the local computing node 180 may publish any data updates to the channel 150 and/or receive data updates from the channel 150, but may be restricted from publishing and/or receiving data updates from the channels 160 and 170 because the local computing node is unsubscribed from the channels 160 and 170. The central server 102 may record and/or track statuses of subscriptions. In some embodiments, the central server 102 may restrict any local computing node from publishing data updates if that local computing node is not updating a most recent version of a document.

FIG. 1B illustrates an example implementation of the computing system 100. In FIG. 1B, the central server 102 may communicate with any of the local computing nodes 180, 182, 184, and 186 through the network 186. In some embodiments, any of the computing nodes 180, 182, 184, and 186 may have APIs or other interfaces 181, 183, 185, and 187, respectively, to communicate with the central server 102.

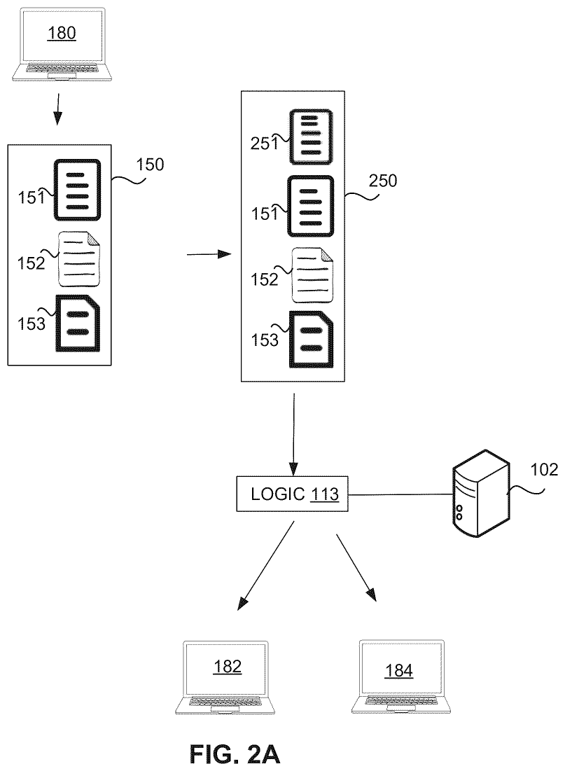

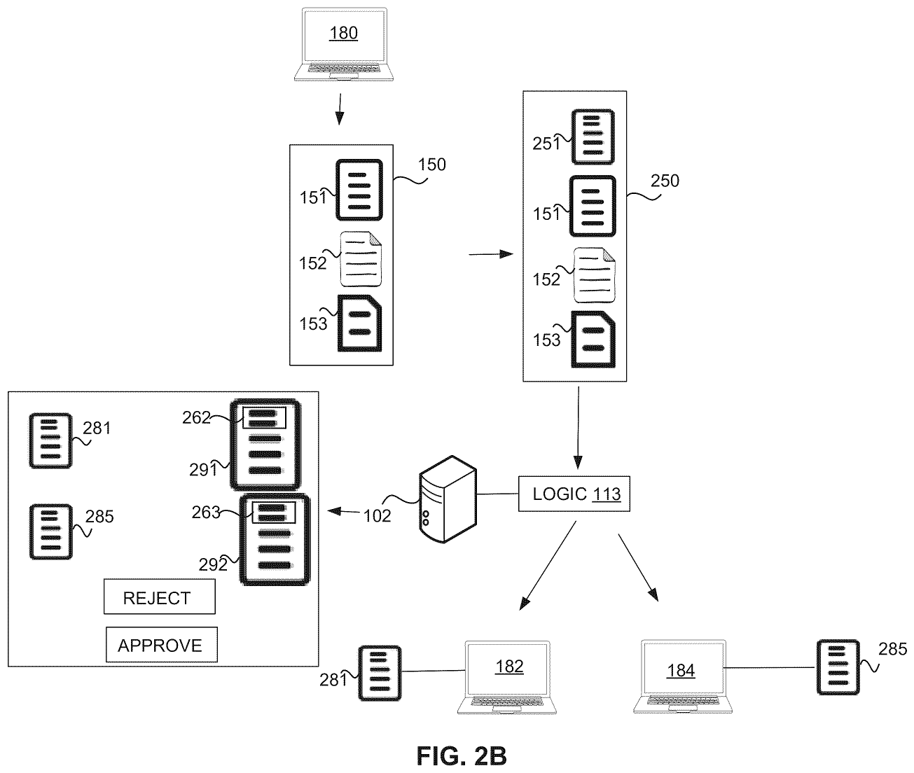

FIG. 2A illustrates an exemplary implementation of synchronizing data updates by the central server 102, which includes a verification protocol. In FIG. 2A, the logic 113 of the central server 102 may obtain, through the channel 150, an update which includes a document 251. The document 251 may have been published by the local computing node 180. The logic 113 may selectively propagate the document 251 to the local computing nodes 182 and 184, which are subscribed to the channel 150. In some embodiments, the logic 113 may first verify whether or not the local computing nodes 182 and 184 intend to synchronize such data updates. The logic 113 may compare the document 251 to any corresponding and/or similar documents that are already stored within the local computing nodes 182 and 184. For example, in FIG. 2B, the logic 113 may detect or receive an indication that corresponding documents 281 and/or 285 are stored within the local computing nodes 182 and 184, respectively. The logic 113 may, for each of the corresponding documents 281 and/or 285, determine and output a difference between the corresponding document and the document 251. For example, the logic 113 may output, within an interface 270, a representation of the document 251, a representation of the document 281, a representation of the document 285, a representation 291 that indicates any differences 262 between the documents 251 and 281, and a representation 293 that indicates any differences 263 between the documents 251 and 285. The logic 113 may selectively synchronize the document 251 with the subscribed local computing nodes 182 and 184, depending on whether an approval is received. If the logic 113 receives an approval, the logic 113 may synchronize the document 251 within the local computing nodes 182 and/or 184. In some embodiments, the logic 113 may synchronize the document 251 by uploading a new document corresponding to the document 251 within the local computing nodes 182 and/or 184, rather than replacing the documents 281 and/or 285. If the logic 113 does not receive an approval, the logic 113 may refrain from synchronizing the document 251 within the local computing nodes 182 and/or 184. Subsequently, if the local computing nodes 182 and/or 184 approve the synchronizing of the document 251, the logic 113 may then synchronize any further updates without approval. In this manner, the logic 113 may verify whether or not the local computing nodes 182 and/or 184 actually intend to synchronize a new document to remove the possibility of unwanted synchronization.

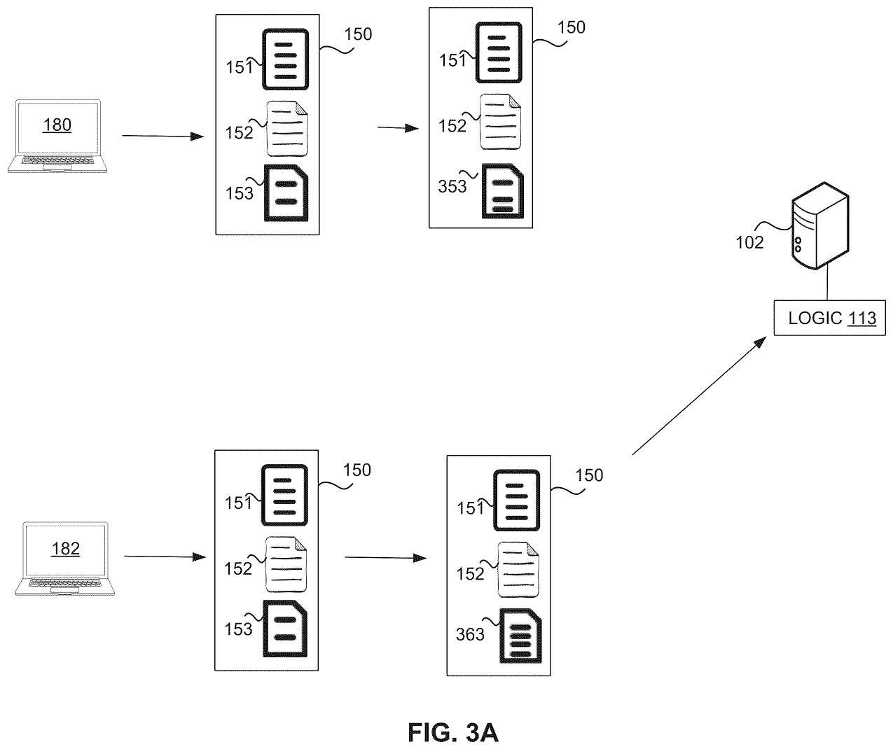

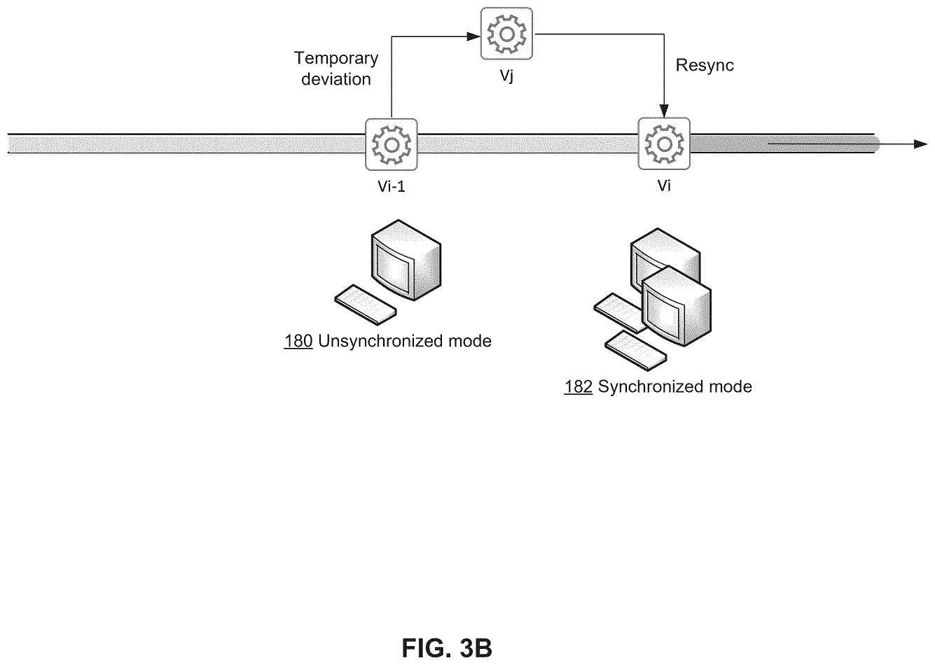

FIG. 3A illustrates an exemplary implementation of different modes of the local computing nodes 180 and 182, including a synchronized mode and an unsynchronized mode. In FIG. 3A, the local computing node 180 is in an unsynchronized mode, in which the local computing node 180 may locally update data, but the data updates are not published at the central server 102. Additionally, the local computing node 180 may not synchronize any updates received at the central server 102, even if the local computing node 180 is subscribed to a channel that has the updates. For example, the local computing node 182 is in a synchronized mode, in which the local computing node 182 may publish a data update, including an updated document 363, within the channel 150. The central server 102 may refrain from synchronizing the updated document 363 at the local computing node 180 because the local computing node 180 is in an unsynchronized mode, even though the local computing node 180 is subscribed to the channel 150. The logic 113 may obtain an indication of when any of the local computing nodes 180, 182, 184, and/or 186 are switching between modes. In some embodiments, any of the local computing nodes 180, 182, 184, and/or 186 may be in a partially synchronized mode, in which the local computing nodes 180, 182, 184, and/or 186 may receive synchronization of only certain types of data updates. In some embodiments, the local computing nodes 180, 182, 184, and/or 186 may be restricted from publishing data updates but may still receive synchronization of data updates. In some embodiments, the local computing nodes 180, 182, 184, and/or 186 may be restricted from receiving synchronization of data updates but may be restricted from publishing data updates.

FIG. 3B illustrates an exemplary diagram in which the local computing node 180 is temporarily in an unsynchronized mode, while the local computing node 182 is in a synchronized mode. The local computing node 180 may have notified the central server 102 regarding the unsynchronized mode, at a state Vᵢ₋₁. The local computing node 180 may have performed a temporary deviation at a state Vⱼ. The temporary deviation may test a configuration change without publishing the configuration change. The local computing node 180 may switch to the synchronized mode at a state Vᵢ, during which the updates made will be published to the central server 102 and resynchronized with the local computing node 182 and/or other local computing nodes subscribed to the channel to which the data update was published. In other embodiments, the updates made locally will be rolled back and the local computing node 180 will be resynchronized with the local computing node 182 and/or other local computing nodes subscribed to the channel to which the data update was published. In some embodiments, the rolling back of the local changes is needed for resynchronization to avoid potential code conflicts. After resynchronization, the local computing node 180 may decide to publish the local updates that it has tested.

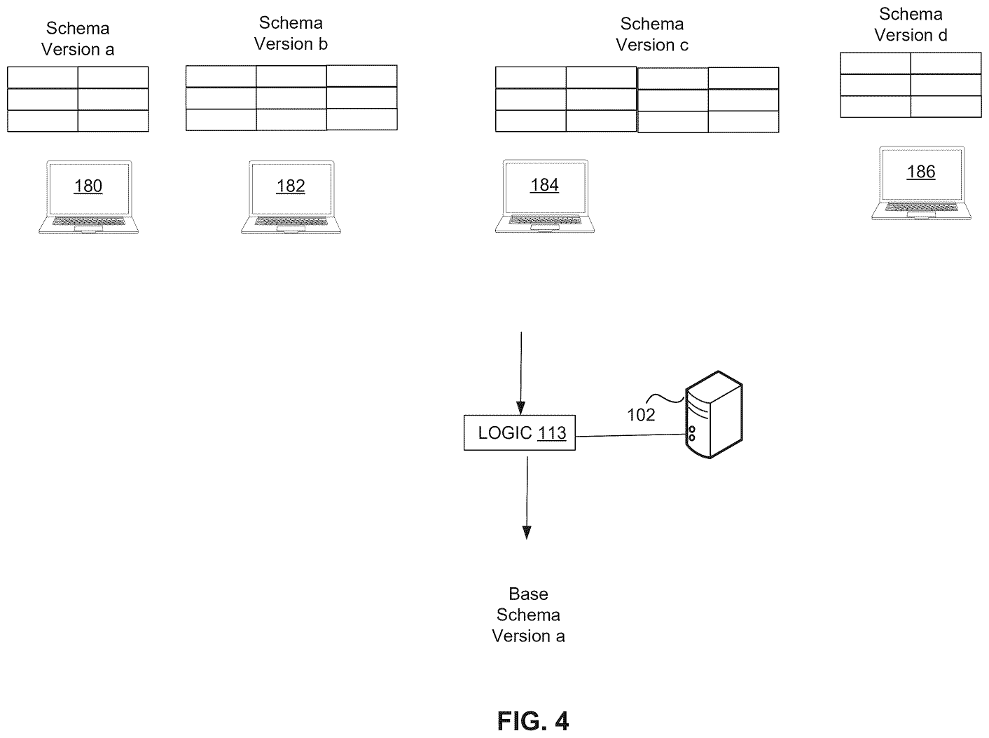

FIG. 4 illustrates an exemplary implementation of schema version controlling, both at the central server 102 and at the local computing nodes 180, 182, 184, and/or 186. In FIG. 4, the logic 113 may receive an indication that the local computing node 180 supports schema version a, the local computing node 182 supports schema version b, the local computing node 184 supports schema version c, and the local computing node 186 supports schema version b. Assume that schema version a is a more rudimentary or earlier version compared to schema version b, and that schema version b is a more rudimentary or earlier version compared to schema version c. Assume also that if a local computing node supports a particular schema version, then that local computing node automatically supports any older or more rudimentary versions. In FIG. 4, the logic 113 may determine a base schema version to be the schema version a because the schema version a is a highest commonly supported version among the local computing nodes 180, 182, 184, and 186. The logic 113 may, in some embodiments, restrict any published data updates to be of the base schema version (e.g., the schema version a). The logic 113 may then synchronize any data updates according to the base schema version. In some embodiments, the logic 113 may update the base schema version once the local computing node 180 updates its base schema version. For example, if the logic 113 receives, from the local computing node 180, a data update that is in schema version b, then the logic 113 may update its base schema version to the schema version b. Subsequently, if the logic 113 were to receive data updates from each of the local computing nodes 180, 182, and 186 in schema version c, then the logic 113 may update its base schema version to the schema version c.

In some embodiments, the logic 113 may, additionally or alternatively, manage the updating of schema versions at the local computing nodes 180, 182, 184, and 186. For example, the logic 113 may restrict or block a particular local computing node from updating its schema version until all other local computing nodes are ready to update their schema versions, and/or until a threshold proportion of the other local computing nodes are ready to update their schema versions. Alternatively, the logic 113 may transmit an indication to the local computing nodes 180, 182, 184, and 186 regarding when to update their schema versions. In this manner, the logic 113 may maintain a relatively uniform distribution of schema versions so that the local computing nodes may eliminate or reduce the amount of schema transformations performed.

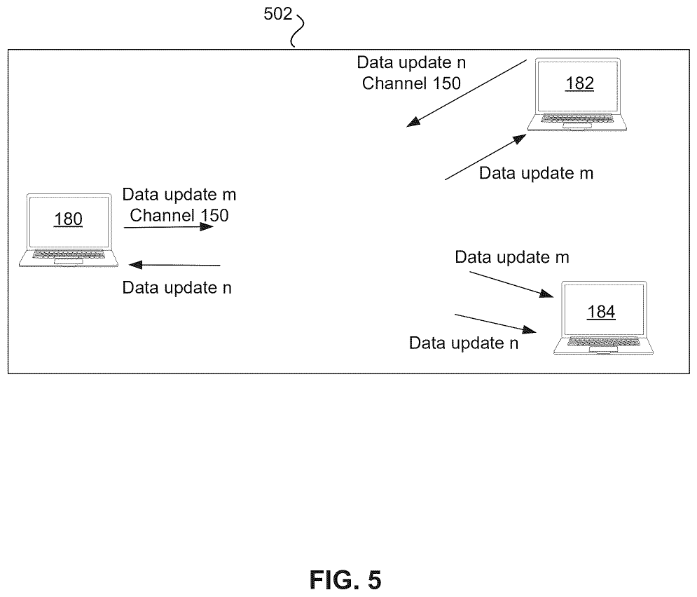

FIG. 5 illustrates an example presentation of a data flow dashboard 502. The data flow dashboard 502 is illustrated merely for exemplary purposes. The data flow dashboard 502 may be implemented on an interface. The data flow dashboard 502 may include any published data updates, a source (e.g., a particular local computing node) that published the data updates, which channels the data updates are being published to, and/or any destinations (e.g., local computing nodes) that are to be synchronized with the data updates. Here, in FIG. 5, the data flow dashboard 502 shows that the local computing node 180 published a data update m in the channel 150, and that the data update m is to be synchronized at the local computing nodes 182 and 184, which are subscribed to the channel 150. Moreover, the local computing node 182 published a data update n, also to the channel 150. The data update n is to be synchronized at the local computing nodes 180 and 184, which are subscribed to the channel 150.

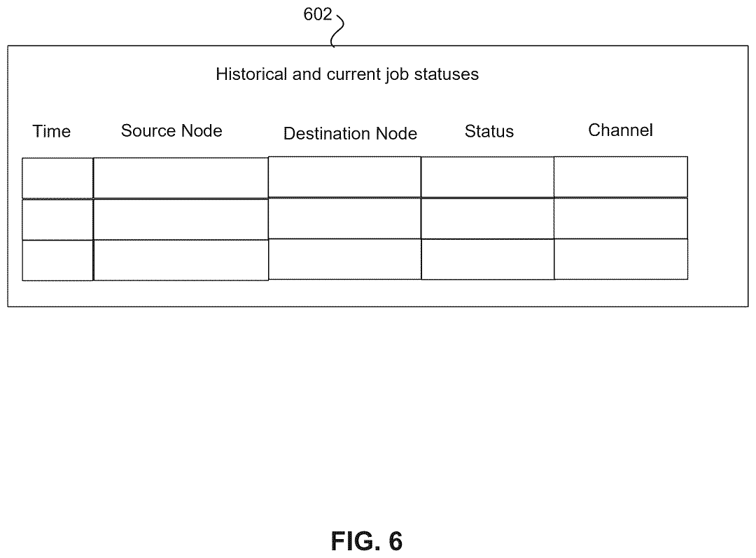

FIG. 6 illustrates an example presentation of a data flow dashboard 602. The data flow dashboard 602 is illustrated merely for exemplary purposes. The data flow dashboard 602 may be implemented on an interface, and may be implemented in conjunction with the data flow dashboard 502 or separately from the data flow dashboard 502. The data flow dashboard 602 may include historical and current job (e.g., data update synchronization) statuses. For example, the data flow dashboard 602 may include starting and/or ending times of jobs, a source node (e.g., a local computing node that published the data update), a destination node (e.g., a local computing node to which the data update is to be synchronized), a status (e.g., whether the job has been completed, is pending, or is in an error status), and a channel to which the data update was published and synchronized from. In some embodiments, the status may indicate a health status of a destination node, and/or may be used to determine a health score of a destination node. For example, a health score may be determined based on a frequency of job errors at a destination node. include any published data updates, a source (e.g., a particular local computing node) that published the data updates, which channels the data updates are being published to, and/or any destinations (e.g., local computing nodes) that are to be synchronized with the data updates. Here, in FIG. 5, the data flow dashboard 502 shows that the local computing node 180 published a data update m in the channel 150, and that the data update m is to be synchronized at the local computing nodes 182 and 184, which are subscribed to the channel 150. Moreover, the local computing node 182 published a data update n, also to the channel 150. The data update n is to be synchronized at the local computing nodes 180 and 184, which are subscribed to the channel 150.

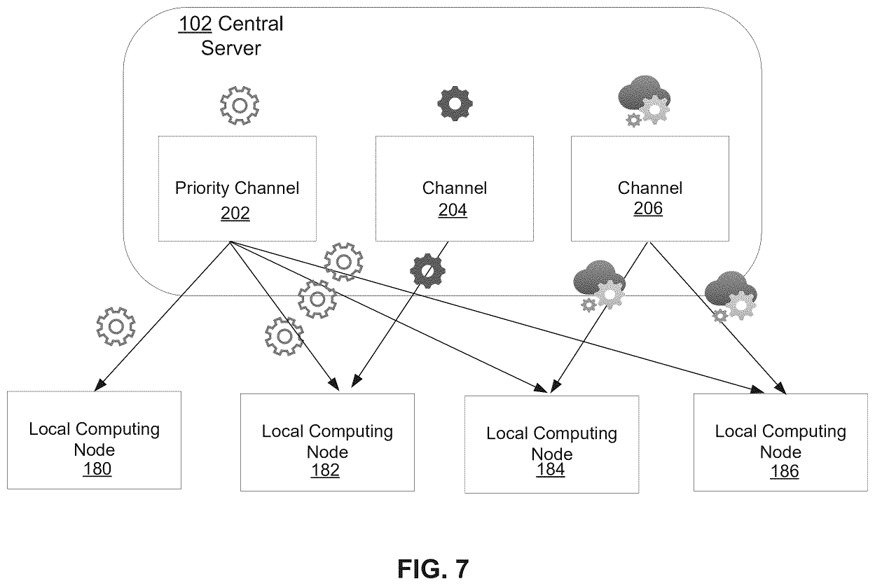

FIG. 7 illustrates a concept of priority channels, which are used to manage the priorities of data updates. In FIG. 7, the local computing nodes 180, 182, 184, and 186 may be subscribed to a priority channel 702. The logic 113 may receive an indication of levels of priority of each channel that each local computing node is subscribed to.

The local computing node 182 may be subscribed additionally to a channel 704 (e.g., a non-priority channel). The local computing node 184 and the local computing node 186 may be subscribed to a channel 706 (e.g., a non-priority channel). In some embodiments, data updates that pertain to same, equivalent, or similar data that is present in different channels may be synchronized according to a priority. For example, assume that data updates pertain to same information or data or equivalent data that is published in the priority channel 702, the channel 704, and the channel 706. The local computing nodes 180, 182, 184, and 186 may synchronize the data updates according to the priority channel 702, over the channels 704 and 706 which are non-priority channels. In this manner, the central server 102 may avoid data conflicts when different channels have concurrent or near concurrent data updates that pertain to the same information or data.

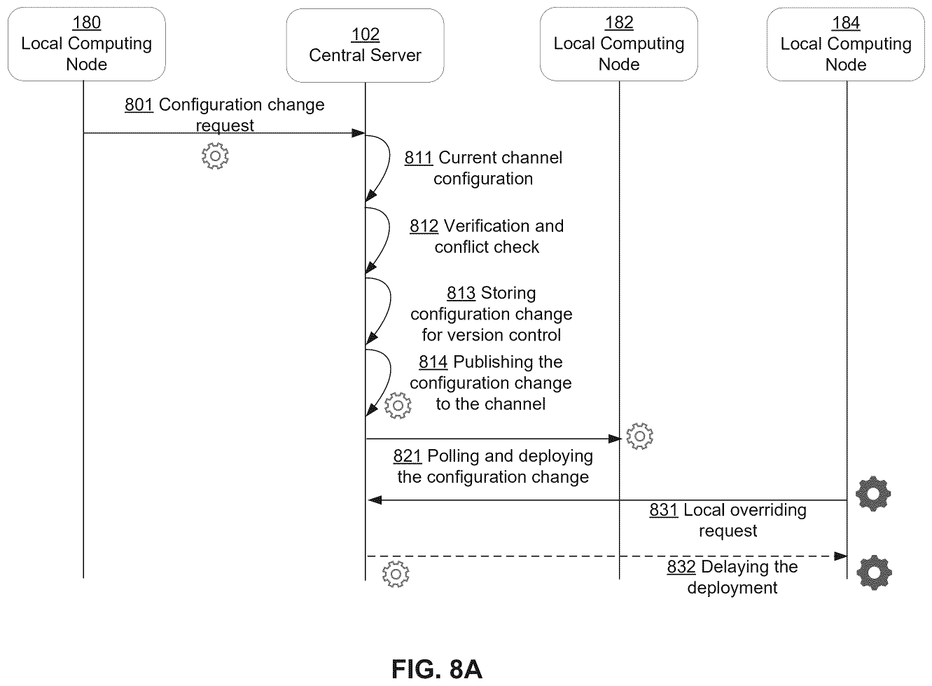

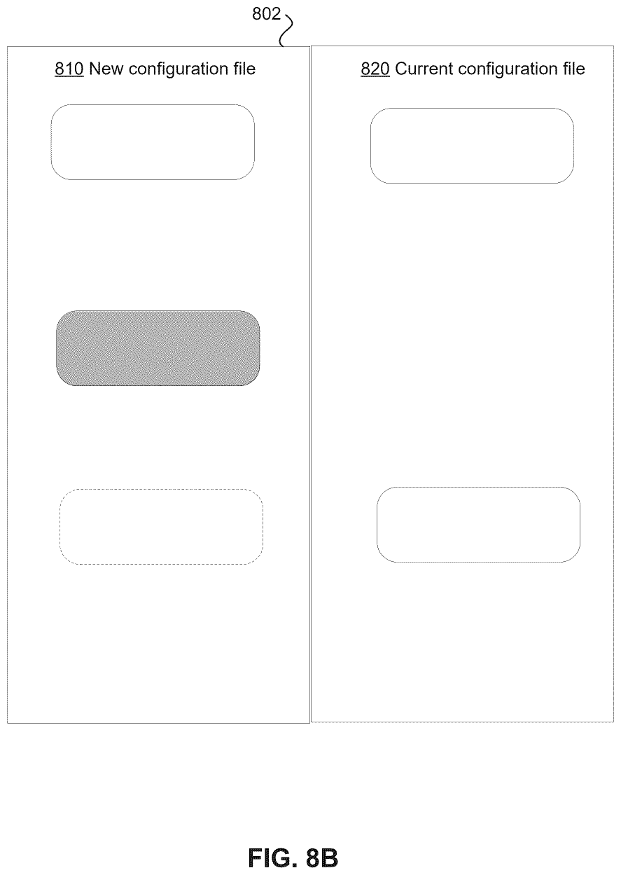

FIG. 8A illustrates a flow diagram in which a local computing node publishes a data update at a particular channel, and the central server 102 synchronizes the data update to any local computing nodes subscribed to that particular channel, in some embodiments. In FIG. 8A, the local computing node 180 publishes a data update, as a configuration change request 801 at the channel 150. The central server 102 verifies a current channel configuration 811 (e.g., whether the channel is in an active and/or valid status) at the channel 150. The central server 102 also performs a verification and conflict check 812 to verify that the data update conforms with any access control restrictions. During the verification and conflict check 812, the central server 102 may also verify whether the data update has been made to a most recent version of the data. If the central server 102 determines that the data update has been made to an outdated version of the data, the central server 102 may invalidate the data update. The central server 102 may then store the validated data update as a new configuration, and/or as a new version, during a configuration change storing process 813. The central server 102 may publish the configuration change to the channel 150, during the publication process 814. In some embodiments, the central server 102 may inform the other local computing nodes 182 and/or 184 that are subscribed to the channel 150 regarding the configuration change. In other embodiments, the central server 102 may obtain a polling request for updated data from the local computing nodes 182 and/or 184. The central server 102 may perform a deployment change during a polling and deployment process 821, which synchronizes the data updates at the subscribed local computing node 182. In some embodiments, the central server 102 may receive a local overriding request 831, which may indicate a request to switch to an unsynchronized mode, from the local computing node 184, The central server 102 may perform a delaying process 832.

In some embodiments, in FIG. 8B, the central server 102 may generate a representation of a current configuration file 820 and a new configuration file 810 following the validated updated, within a dashboard 802. The differences between the two files are highlighted to facilitate code review and code conflict management.

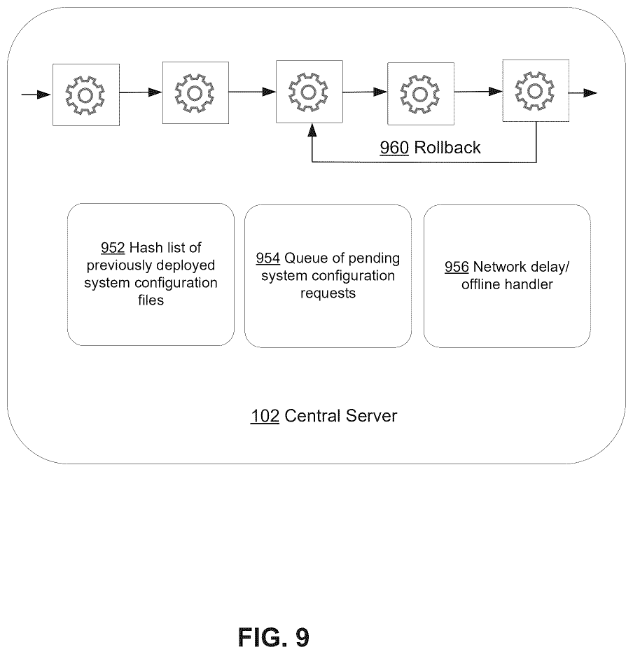

FIG. 9 is a diagram that illustrates an implementation of the central server 102. In FIG. 9, the central server 102 may store a hashed list 952, which includes hash representations of previously deployed system configuration files (e.g., previous states of channels, or of documents within channels). Thus, every time a local computing node publishes a data update, that data update is hashed and stored. The hashed list 952 may enable the central server 102 to implement a rollback 960, which reverts a local computing node to an earlier state. The central server 102 may also store a queue 954 of pending system configuration requests (e.g., received polling requests from one or more local computing nodes and/or local computing nodes that need to be synchronized). The central server 102 may also include a network delay or offline handler 956, which stores modes (e.g., a synchronized or unsynchronized mode) of the local computing nodes. If a local computing node is in an unsynchronized mode, the central server 102 may record any data updates within any subscribed channels during a duration of the unsynchronized mode and may synchronize the local computing node such that the local computing node returns to a synchronized mode.

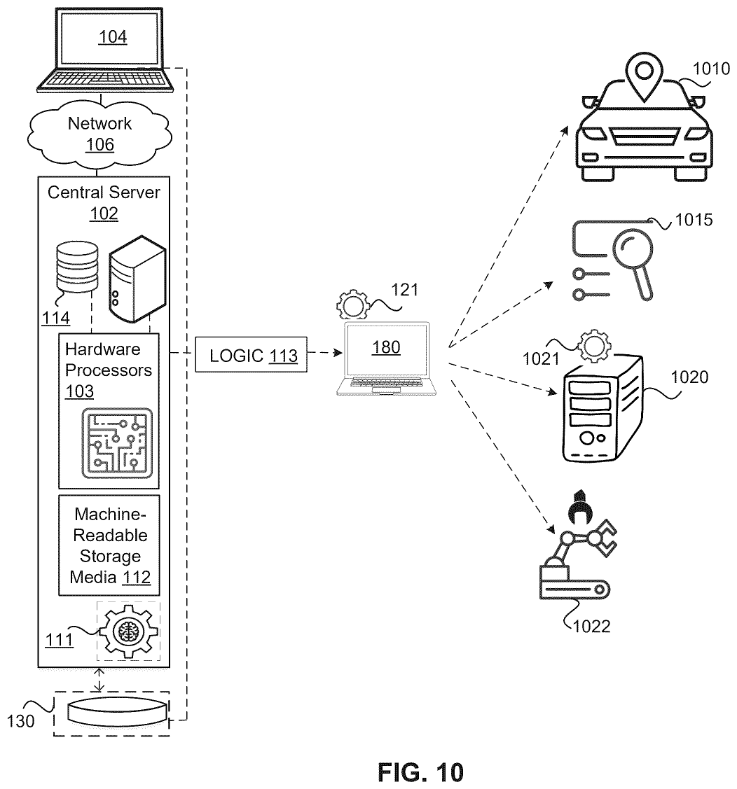

FIG. 10 is a diagram that illustrates potential downstream actions as a result of publication and synchronization of updates from and to local computing nodes as illustrated in the previous FIGS. The data synchronization may trigger, within any of the local computing nodes and/or other computing systems, certain downstream actions, such as, additional workflow processes including performing navigation 1010, additional monitoring 1015, transmitting and/or writing information to a different computing system 1020, for example, via an API 1021, and/or maintenance or other physical operations 1022. Such additional workflow processes may take place as a foreground or a background process. As an example of the additional monitoring 1015, assume that the logic 113, and/or machine learning components 111, may infer or determine attributes or parameters associated with one or more objects. If one, or any of, the attributes or parameters fall outside of operating ranges or thresholds, then the logic 113, or a different computing system, may trigger an alert, and/or may initiate additional monitoring or recording of the attributes or parameters, and/or of different attributes or parameters. In other examples, the logic 113 may, additionally or alternatively, trigger monitoring or recording of other entity types, which may be affected by the attributes or parameters. This monitoring or recording of other entity types may be delegated to a different computing system. In other examples, a downstream action may include a transmission or presentation of information, an alert, and/or a notification to the to the computing device 120 and/or to other devices. The information may include indications of which attributes or parameters fall outside of operating ranges or thresholds, or reasons that an alert was triggered, and/or one or more timestamps corresponding to an originating or creation time of underlying data that caused the triggering of the alert. Alternatively, an alert may be triggered using a predicted time at which an attribute or parameter may be predicted to fall outside of an operating range or threshold.

In yet other examples, a downstream action may entail an applications programming interface (API) 121 of the local computing node 180 interfacing with or calling the API 1021 of the different computing system 1020. For example, the different computing system 1020 may perform modification of data. The modification may encompass creating, editing, or removing entities or links, and/or adjusting attributes or parameters that are falling outside of an operating range or threshold, through some electronic or physical operation.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software. Operating systems control and schedule computer processes for execution, perform memory management, provide file system, networking, I/O services, and provide a user interface functionality, such as a graphical user interface (“GUI”), among other things.

In some embodiments, AI components, such as large language models (LLMs) may be implemented to carry out any of the aforementioned functions described in the previous FIGS. For example, a LLM may be implemented to receive a request to publish data updates to a specific channel, and/or to a specific local computing node. For example, a LLM may publish data updates to a specific local computing node by determining one or more channels that the specific local computing node is subscribed to publishing the data updates to a most relevant channel.

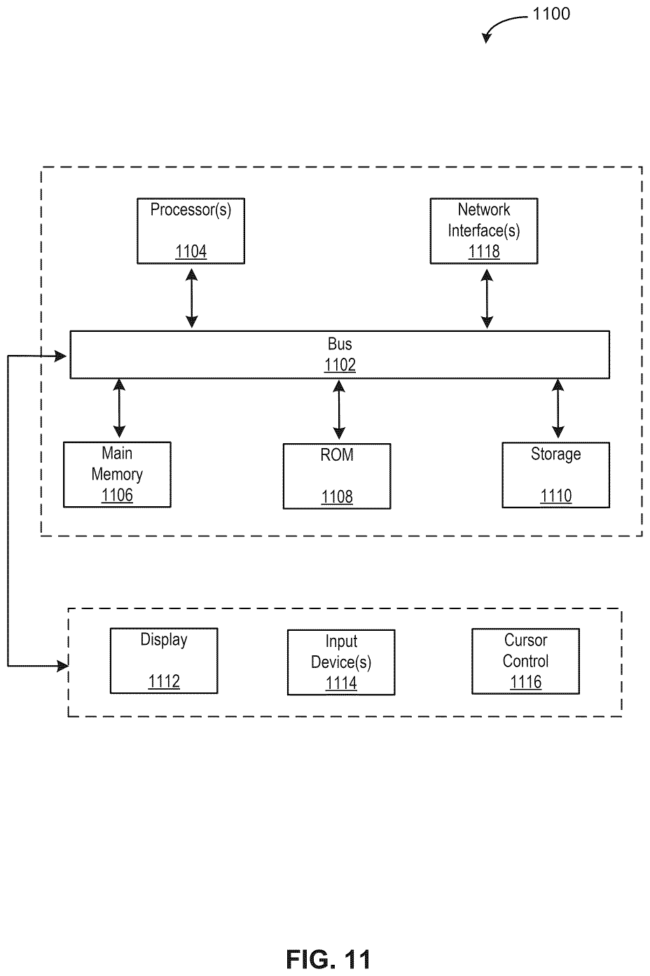

FIG. 11 is a block diagram that illustrates a computer system 1100 upon which any of the embodiments described herein may be implemented. In some examples, the computer system 1100 may include a cloud-based or remote computing system. For example, the computer system 1100 may include a cluster of machines orchestrated as a parallel processing infrastructure. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

The computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

The computer system 1100 may be coupled via bus 1102 to a display 1112, such as a cathode ray tube (CRT) or LCD display (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may retrieves and executes the instructions. The instructions received by main memory 1106 may optionally be stored on storage device 1110 either before or after execution by processor 1104.

The computer system 1100 also includes a communication interface 1118 coupled to bus 1102. Communication interface 1118 provides a two-way data communication coupling to one or more network links that are connected to one or more local networks. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN (or WAN component to communicated with a WAN). Wireless links may also be implemented. In any such implementation, communication interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 1118, which carry the digital data to and from computer system 1100, are example forms of transmission media.

The computer system 1100 can send messages and receive data, including program code, through the network(s), network link and communication interface 1118. In the Internet example, a server might transmit a requested code for an application program through the Internet, the ISP, the local network and the communication interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be removed, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that “logic,” a “system,” “data store,” and/or “database” may comprise software, hardware, firmware, and/or circuitry. In one example, one or more software programs comprising instructions capable of being executable by a processor may perform one or more of the functions of the data stores, databases, or systems described herein. In another example, circuitry may perform the same or similar functions. Alternative embodiments may comprise more, less, or functionally equivalent systems, data stores, or databases, and still be within the scope of present embodiments. For example, the functionality of the various systems, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any figure or example can be combined with one or more features of any other figure or example. A component being implemented as another component may be construed as the component being operated in a same or similar manner as the another component, and/or comprising same or similar features, characteristics, and parameters as the another component.

The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to an “example” or “examples” means that a particular feature, structure or characteristic described in connection with the example is included in at least one example of the present invention. Thus, the appearances of the phrases “in one example” or “in some examples” in various places throughout this specification are not necessarily all referring to the same examples, but may be in some instances. Furthermore, the particular features, structures, or characteristics may be combined in any suitable manner in one or more different examples.

What is claimed is:

1. A computer-implemented method by a server, wherein the server comprises a plurality of channels, a plurality of client devices subscribed to the plurality of channels, and the method comprises:
receiving a system configuration change request from a client device, wherein the system configuration change request comprises a first system configuration file and channel information of a first channel;
obtaining, based on the channel information, a second system configuration file that is currently deployed on client devices subscribed to the first channel;
displaying, on a graphic user interface (GUI), a file comparison result between the first system configuration file and the second system configuration file; and
in response to the file comparison result being verified, storing the first system configuration file in a request queue for the client devices to poll and deploy.

2. The computer-implemented method of claim 1, further comprising:
computing a file fingerprint of the first system configuration file;
searching for the file fingerprint in a hash list, the hash list comprising hashes of previously deployed system configuration files; and
in response to the file fingerprint having no match in the hash list, generating the file comparison result by comparing the first system configuration file and the second system configuration file.

3. The computer-implemented method of claim 2, further comprising:
in response to the file fingerprint being matched in the hash list, sending an alert to the client device indicating that the first system configuration file is not being deployed.

4. The computer-implemented method of claim 1, wherein the method further comprises:
determining whether the request queue has a pending request that matches with the system configuration change request by comparing file fingerprints of the pending request and the system configuration change request; and
in response to that the system configuration change request matches with any pending request in the request queue, removing the system configuration change request from the queue.

5. The computer-implemented method of claim 1, further comprising:
generating a dashboard displaying the plurality of channels, the client devices subscribed to each of the plurality of channels, and current system configurations on the client devices.

6. The computer-implemented method of claim 1, wherein one client devices is allowed to subscribe to more than one of the plurality of channels.

7. The computer-implemented method of claim 1, wherein the system configuration change request is channel-specific, and only client devices subscribed to the first channel are allowed to poll the system configuration change request.

8. The computer-implemented method of claim 1, further comprising:
storing a list of the client devices subscribed to the first channel;
receiving a local overriding request from a second client device in the client devices, wherein the local overriding request indicates that the second client device is intended to make local changes to the first system configuration file;
temporarily removing the second client device from the list; and
enforcing, based on the first system configuration file, a system configuration update on the remaining client devices in the list.

9. The computer-implemented method of claim 1, wherein the displaying the file comparison result between the first system configuration file and the second system configuration file on the GUI comprises:
displaying a window comprising a first area and a second area, wherein the first system configuration file is displayed in the first area, and the second system configuration file is displayed in the second area; and
highlighting code differences between the first system configuration file and the second system configuration file using color coding.

10. The computer-implemented method of claim 1, further comprising:
receiving, periodically, configuration probing requests from the client devices to obtain updated status of one or more recommended deployments comprising the deployment of the first system configuration file on the client devices; and
receiving hashes from the client devices, wherein the hashes represent configuration files deployed on the client devices.

11. The computer-implemented method of claim 1, further comprising:
storing the second system configuration file in a log file, allowing a system-wise roll-back from the deployed first system configuration file to the second system configuration file.

12. The computer-implemented method of claim 1, further comprising:
collecting network traffic data between the server and the plurality of client devices, the network traffic data comprising at least one of network delay, package loss, or jitter;
in response to the network traffic data between the server and a third client device being greater than a threshold, adding the first system configuration file into a cache queue associated with the third client device, wherein the cache queue stores one or more system configuration files that are not yet deployed on the third client device; and
in response to the network traffic data between the server and a third client device being below the threshold, deploying the one or more system configuration files in the cache queue sequentially onto the third client device.

13. A system of a server, wherein the server is associated with a plurality of channels, a plurality of client devices subscribed to the plurality of channels, and the server comprises:
one or more processors; and
memory storing instructions that, when executed by the one or more processors, cause the system to perform operations comprising:
receiving a system configuration change request from a client device, wherein the system configuration change request comprises a first system configuration file and channel information of a first channel;
obtaining, based on the channel information, a second system configuration file that is currently deployed on client devices subscribed to the first channel;
displaying, on a graphic user interface (GUI), a file comparison result between the first system configuration file and the second system configuration file; and
in response to the file comparison result being verified, storing the first system configuration file in a request queue for the client devices to poll and deploy.

14. The system of claim 13, wherein the operations further comprise:
computing a file fingerprint of the first system configuration file;
searching for the file fingerprint in a hash list, the hash list comprising hashes of previously deployed system configuration files; and
in response to the file fingerprint having no match in the hash list, generating the file comparison result by comparing the first system configuration file and the second system configuration file, wherein the operations further comprise:
in response to the file fingerprint being matched in the hash list, sending an alert to the client device indicating that the first system configuration file is not being deployed.

15. The system of claim 14, further comprising a Large Language Model (LLM) that receives a request to synchronize a data update at a client device, publishes the data update to a channel to which the client device is subscribed, and synchronizes the client device according to the published data update.

16. The system of claim 13, wherein the operations further comprise:
determining whether the request queue has a pending request that matches with the system configuration change request by comparing file fingerprints of the pending request and the system configuration change request; and
in response to that the system configuration change request matches with any pending request in the request queue, removing the system configuration change request from the queue.

17. The system of claim 13, wherein one client devices is permitted to subscribe to more than one of the plurality of channels.

18. The system of claim 13, wherein the operations further comprise:
storing a list of the client devices subscribed to the first channel;
receiving a local overriding request from a second client device in the client devices, wherein the local overriding request indicates that the second client device is intended to make local changes to the first system configuration file;
temporarily removing the second client device from the list; and
enforcing, based on the first system configuration file, a system configuration update on the remaining client devices in the list.

19. The system of claim 13, wherein the displaying the file comparison result between the first system configuration file and the second system configuration file on the GUI comprises:
displaying a window comprising a first area and a second area, wherein the first system configuration file is displayed in the first area, and the second system configuration file is displayed in the second area; and
highlighting code differences between the first system configuration file and the second system configuration file using color coding.

20. A non-transitory computer readable media of a server, wherein the server comprises a plurality of channels, a plurality of client devices subscribed to the plurality of channels, and non-transitory computer readable media comprises instructions that, when executed, cause one or more processors to perform operations comprising:
receiving a system configuration change request from a client device, wherein the system configuration change request comprises a first system configuration file and channel information of a first channel;
obtaining, based on the channel information, a second system configuration file that is currently deployed on client devices subscribed to the first channel;
displaying, on a graphic user interface (GUI), a file comparison result between the first system configuration file and the second system configuration file; and
in response to the file comparison result being verified, storing the first system configuration file in a request queue for the client devices to poll and deploy.
